(19) United States
(12) Patent Application Publication
(10) Pub. No.: US 2019/0243360 A1
(43) Pub. Date: Aug. 8, 2019

(54) MODE SWITCH CONTROLLER, MODE SWITCH CONTROL SYSTEM, MODE SWITCH CONTROL METHOD, AND PROGRAM

(71) Applicant: OMRON Corporation, Kyoto-shi (JP)

(72) Inventors: Mei UETANI, Uji-shi (JP); Tadashi HYUGA, Hirakata-shi (JP); Hatsumi AOI, Kyotanabe-shi (JP)

(73) Assignee: OMRON Corporation, Kyoto-shi (JP)

(21) Appl. No.: 16/384,375

(22) Filed: Apr. 15, 2019

Related U.S. Application Data
(63) Continuation of application No. PCT/JP2017/033147, filed on Sep. 13, 2017.

(30) Foreign Application Priority Data
Mar. 9, 2017 (JP) 2017-045137

(51) Int. Cl. G05D 1/00; B60Q 9/00; B60W 50/14; B60W 30/18

(52) U.S. Cl. CPC G05D 1/0061; B60Q 9/00; B60W 2050/0072; B60W 30/18; B60W 50/14

(57) ABSTRACT

A mode switch controller controls mode switching for switching a drive mode of a vehicle between a manual drive mode and an automatic drive mode. The mode switch controller includes an obtaining unit and a calculation unit. The obtaining unit obtains sensing data representing a surrounding situation in a switching section defined for the mode switching from a sensor for monitoring surroundings of the vehicle. The calculation unit calculates a recommended mode switching position at which the mode switching is recommended in the switching section based on the sensing data.

### CROSS REFERENCE TO RELATED APPLICATIONS

This application is a continuation application of International Application No. PCT/JP2017/033147, filed on Sep. 13, 2017, which claims priority based on the Article 8 of Patent Cooperation Treaty from prior Japanese Patent Application No. 2017-045137, filed on Mar. 9, 2017, the entire contents of which are incorporated herein by reference.

### FIELD

The disclosure relates to a technique for switching the drive mode of a vehicle between a manual drive mode and an automatic drive mode.

### BACKGROUND

As techniques for automating vehicle driving have been receiving attention, the automatic drive mode is now under consideration for use. In the automatic drive mode, a computer mainly operates a vehicle, unlike in a manual drive mode in which a driver, relying on his or her perception, operates a vehicle with hands and feet.

The automatic drive mode enables automatic driving of a vehicle by controlling, for example, a power unit, a steering unit, and a brake based on various items of information obtained with various sensors or through communications. Such information includes position measurement information obtained from a global positioning system (GPS), map information from a car navigation system, traffic information obtained through road-to-vehicle communication, monitoring information from a surrounding monitoring system that monitors the positions and movements of nearby pedestrians and vehicles, and posture information of a vehicle obtained from a three-axis sensor.

The automatic drive mode is expected to reduce the burden of drivers or to ease traffic congestion. However, a driver may have some situations to hold the steering wheel and drive the vehicle on a route from a starting point to a destination. For example, the driver may use the automatic drive mode on expressways, but may use the manual drive mode on ordinary roads as appropriate. Techniques are to be developed for safely switching between the automatic drive mode and the manual drive mode.

For example, Japanese Unexamined Patent Application Publication No. 2015-141560 describes a technique for changing the timing to stop automatic driving. Japanese Unexamined Patent Application Publication No. 2015-141560 describes resetting the timing to stop automatic driving as requested by the driver when any event that can stop automatic driving is found on the route ahead. However, no technique is described therein for determining an appropriate time point for switching and recommending the time point to the driver in response to the driver's request to switch from the automatic drive mode to the manual drive mode.

Various techniques have been developed for switching between the automatic drive mode and the manual drive mode. In one example, a preparatory time period for switching (e.g., 60 sec) is defined, during which preparations including looking around to ensure safety are performed before the drive mode switching. In another example, a switching section with a predetermined distance (e.g., about 100 meters to several kilometers) may be defined on a route before an interchange to allow the driver to have a sufficient time to switch the drive mode.

The switching section may include positions (or places) appropriate or inappropriate for the drive mode switching. Also, the appropriate switch positions can change over time as the surrounding situation changes. Effectively recommending an appropriate position for mode switching to a driver can enhance the driver's safety in the drive mode switching.

One or more aspects are directed to a mode switch controller, a mode switch control system, a mode switch control method, and a program that enable drive mode switching at an appropriate position to improve safety.

### SUMMARY

A mode switch controller according to one or more aspects controls mode switching to switch a drive mode of a vehicle between a manual drive mode and an automatic drive mode. The controller includes an obtaining unit that obtains, from a sensor for monitoring surroundings of the vehicle, sensing data representing a surrounding situation in a switching section defined for the mode switching, and a calculation unit that calculates a recommended mode switching position at which the mode switching is recommended in the switching section based on the sensing data.

A mode switch control system according to one or more aspects controls mode switching to switch a drive mode of a vehicle between a manual drive mode and an automatic drive mode. The system includes a sensor that monitors surroundings of the vehicle and outputs sensing data representing a surrounding situation of the vehicle, an obtaining unit that obtains the sensing data in a switching section defined for the mode switching from the sensor, and a calculation unit that calculates a recommended mode switching position at which the mode switching is recommended in the switching section based on the sensing data.

A mode switch control method according to one or more aspects controls, with a computer, mode switching to switch a drive mode of a vehicle between a manual drive mode and an automatic drive mode. The method includes obtaining, with the computer, sensing data representing a surrounding situation in a switching section defined for the mode switching from a sensor for monitoring surroundings of the vehicle, and calculating, with the computer, a recommended mode switching position at which the mode switching is recommended in the switching section based on the sensing data.

A program according to one or more aspects causes a computer, which controls mode switching to switch a drive mode of a vehicle between a manual drive mode and an automatic drive mode, to execute an instruction for obtaining, from a sensor for monitoring surroundings of the vehicle, sensing data representing a surrounding situation in a switching section defined for the mode switching, and an instruction for calculating a recommended mode switching position at which the mode switching is recommended in the switching section based on the sensing data.

A mode switch controller according to one or more aspects is the controller according to one or more aspects in which the calculation unit calculates the recommended mode switching position using a distribution of objects around the vehicle as a criterion.

A mode switch controller according to one or more aspects is the controller according to one or more aspects in which the calculation unit determines a position with a lowest distribution density of the objects in the switching section as the recommended mode switching position.

A mode switch controller according to one or more aspects is the controller according to one or more aspects further including a notification controller that notifies the recommended mode switching position to a driver of the vehicle.

A mode switch controller according to a one or more aspects is the controller according to one or more aspects in which the notification controller displays the recommended mode switching position superimposed on a map image of the surroundings of the vehicle on a display included in the vehicle.

A mode switch controller according to one or more aspects is the controller according to one or more aspects in which the calculation unit calculates a distribution of numerical indexes each indicating a degree of recommendation about the mode switching in the switching section, and the notification controller associates the indexes with display colors on the map image to display the indexes in a color map.

A mode switch controller according to one or more aspects is the controller according to one or more aspects in which the notification controller notifies, with a voice, a time length to reach the recommended mode switching position to the driver of the vehicle.

A mode switch controller according to one or more aspects is the controller according to one or more aspects in which a radar device obtains the sensing data.

A mode switch controller according to one or more aspects is the controller according to one or more aspects in which an image sensor obtains the sensing data.

### Advantageous Effects

The mode switch controller, the mode switch control system, the mode switch control method, and the program according to one or more aspects obtains sensing data representing a surrounding situation in a switching section defined for mode switching (e.g., video data and radar data representing the area ahead of the vehicle) from a sensor for monitoring the surroundings of the vehicle (e.g., a front monitoring camera and an in-vehicle radar device). The sensing data is used to calculate a recommended mode switching position at which the mode switching is recommended in the switching section.

This structure calculates a position particularly recommended in the switching section as the recommended mode switching position, which may be stored into, for example, a memory in an in-vehicle computer. Based on the above information, for example, the automatic driving controller in the vehicle may automatically perform various control operations for switching the drive mode using the recommended mode switching position as a target point. This enables the drive mode switching at a recommended position to improve safety in mode switching.

The controller according to one or more aspects calculates the recommended mode switching position using the distribution details of objects around the vehicle (e.g., vehicles traveling in the same lane, vehicles traveling in the same direction but in different lanes, vehicles traveling in opposite lanes, and pedestrians and buildings) as a criterion. This structure calculates the recommended mode switching position based on the positional relationship between the vehicle and each object and thus improves safety in mode switching.

The controller according to one or more aspects calculates a position with the lowest distribution density of objects around the vehicle as the recommended mode switching position. This structure determines a position most unlikely to be affected by traffic obstacles as the recommended mode switching position and thus improves safety. The distribution details and the distribution density of objects are not limited to values currently calculated and may be values at any time point in the future (or in the past).

The controller according to one or more aspects notifies, with the notification controller, the recommended mode switching position to the vehicle driver. This structure allows the driver to have a sufficient time to take over the control (such as looking around or taking over the operation of depressing the accelerator) before reaching the recommended mode switching position. The structure also allows the drive mode switching at a position with fewer obstacles. The mode switching can thus be effectively recommended at an appropriate position, thus effectively supporting the driver's safety and greatly improving safety in mode switching.

The controller according to one or more aspects displays the recommended mode switching position superimposed on the map image of the surroundings of the vehicle appearing on a display (e.g., a touchscreen of a car navigation system, a head-up display, and a display of a smartphone or a tablet). The driver can thus visually recognize the recommended mode switching position, thus having greatly improved safety in mode switching.

The controller according to one or more aspects calculates, with the calculation unit, the distribution of numerical indexes each indicating the degree of recommendation about the mode switching in the switching section. The notification controller associates the indexes with display colors on the map image to display the indexes in a color map. The numerical indexes each indicating the degree of recommendation about the mode switching are, for example, the inverse numbers of the distribution densities of the objects. More specifically, the index values are greater at positions with lower distribution densities of objects. The indexes may also be calculated based on other various parameters such as road surface conditions and geometries or the size and predictive weight of an oncoming vehicle.

For, example, the switching section may be displayed on a display by using a bar or strip icon. The depth of a display color (or hues of display colors) in the bar may be associated with the indexes. The driver can thus readily recognize the positions appropriate and inappropriate for mode switching. This greatly improves safety in mode switching.

The controller according to one or more aspects notifies, with the notification controller, with a voice, a time length to reach the recommended mode switching position to the driver. For example, the driver may be notified of the time period from the current time to the estimated time of passing through the recommended mode switching position by counting down the time. The driver can thus audibly recognize the recommended mode switching position and thus visually concentrate on monitoring the surroundings. This greatly improves safety in mode switching.

The controller according to one or more aspects obtains, with the radar device, the sensing data. Thus, the surrounding conditions (e.g., the distribution of vehicles) may be calculated accurately in darkness.

The controller according to one or more aspects obtains, with the image sensor, the sensing data, which may provide clearer video data than a radar device in some environments.

The controller, the system, the method, and the program according to one or more aspects enable drive mode switching at an appropriate position and thus improve safety.

### BRIEF DESCRIPTION OF THE DRAWINGS

FIG. 1 is a block diagram illustrating an automatic driving control system including a mode switch controller according to one or more embodiments.

FIG. 2 is a functional block diagram illustrating a mode switch controller, such as in FIG. 1.

FIG. 3 is a flow diagram illustrating an example procedure performed by a mode switch controller, such as in FIG. 2.

FIG. 4 is a diagram illustrating an example distribution of vehicles within and around a switching section.

FIG. 5 is a diagram illustrating an example distribution of recommendation degrees in a situation, such as in FIG. 4.

FIG. 6 is a diagram illustrating an example navigation screen appearing on a display 9.

FIG. 7 is a diagram illustrating another example distribution of vehicles and another example distribution of recommendation degrees within and around a switching section.

FIG. 8 is a diagram illustrating another example navigation screen appearing on a display.

FIG. 9 is a flow diagram illustrating another example procedure performed by a mode switch controller, such as in FIG. 2.

FIG. 10 is a diagram illustrating an example video image captured in a field of view of a front monitoring camera.

FIG. 11 is a diagram illustrating an example voice message output from a speaker.

FIG. 12 is a diagram illustrating another example voice message output from a speaker.

### DETAILED DESCRIPTION

### Embodiments

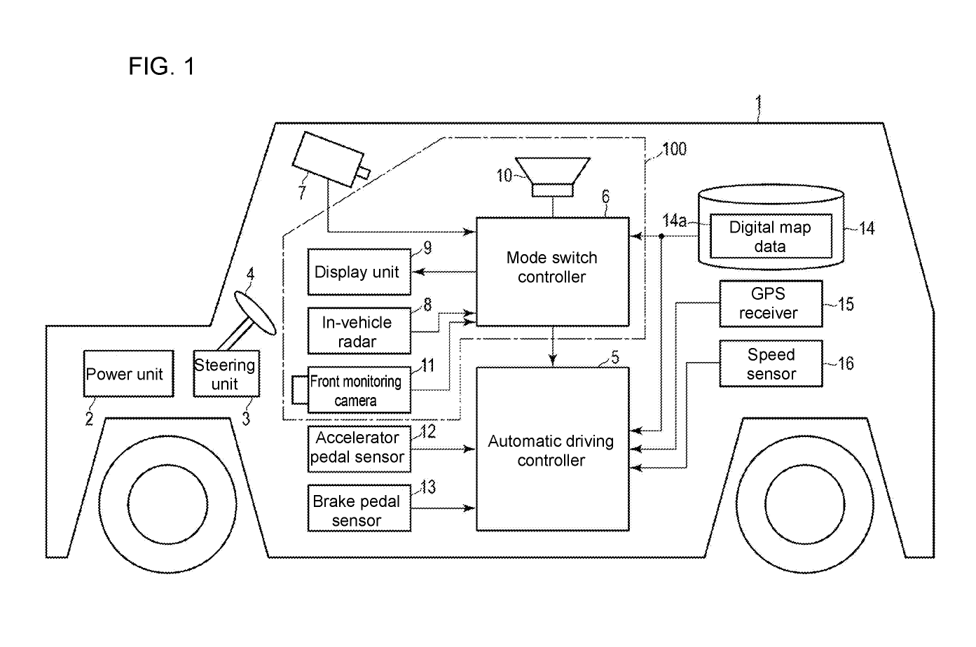

One or more embodiments will now be described with reference to the drawings. FIG. 1 is a block diagram of an automatic driving control system including a mode switch controller according to one or more embodiments. The automatic driving control system is mounted on a vehicle 1. The vehicle 1 can travel either in a manual drive mode or an automatic drive mode. The vehicle 1 includes, as its basic components, a power unit 2 and a steering unit 3. The power unit 2 includes a power supply and a transmission. The power supply includes an internal combustion engine, an electric motor, or both. The steering unit 3 is connected to a steering wheel 4.

The manual drive mode allows the vehicle 1 to travel mainly based on, for example, a manual driving operation performed by a driver. For example, the manual drive mode may include a vehicle driving operation mode for driving a vehicle with a driving operation performed by the driver alone, and an assisted drive mode for driving a vehicle mainly with a driving operation performed by a driver in combination with assisted driving.

For example, when the vehicle 1 travels along a curve, assisted driving assists the driver with steering the vehicle to allow traveling along the curvature of the curve. Assisted driving may further include control for assisting in the driver's acceleration (e.g., accelerator pedal operation) or the braking (e.g., brake pedal operation), manual steering (manual steering during driving), and manual speed regulation (manual speed control during driving). Manual steering refers to steering the vehicle 1 mainly with the driver's operation on the steering wheel 4. Manual speed regulation refers to adjusting the speed of the vehicle mainly with the driver's accelerating operation or braking operation.

In contrast, the automatic drive mode enables, for example, automatic driving of a vehicle along a road on which the vehicle is traveling. The automatic drive mode may include automatic driving of a vehicle to a predetermined destination without the driver performing a driving operation. The automatic drive mode is not limited to complete automatic control of the vehicle. For example, the automatic drive mode may include driving that reflects the driver's operation in the traveling vehicle within a predetermined allowable range.

The automatic driving controller 5 shown in FIG. 1 controls driving in the automatic drive mode. The automatic driving controller 5 obtains sensing data from an accelerator pedal sensor 12, a brake pedal sensor 13, a global positioning system (GPS) receiver 15, and a speed sensor 16. The automatic driving controller 5 controls the traveling of the vehicle 1 based on the sensing data, digital map data 14a stored in a storage 14, route information generated by a navigation system (not shown), traffic information obtained through road-to-vehicle communication, and information obtained by a surrounding monitoring system that monitors the positions and movements of nearby pedestrians and vehicles.

The automatic control includes, for example, autosteering (automatic steering during driving) and automatic speed regulation (automatic speed regulation during driving). Autosteering enables a driving state in which the steering unit 3 is controlled automatically. Autosteering includes lane keeping assist (LKA). LKA automatically controls the steering unit 3 to prevent the vehicle 1 from leaving the driving lane when, for example, the driver is not performing a steering operation. During the operation of LKA, the steering operation of the driver may be reflected in the vehicle steering within the range in which the vehicle 1 stays in the driving lane (allowable range). Autosteering is not limited to LKA.

Automatic speed regulation enables a driving state in which the speed of the vehicle 1 is controlled automatically. Automatic speed regulation includes adaptive cruise control (ACC). For example, ACC controls the vehicle 1 to travel at a predefined constant speed while no preceding vehicle is traveling ahead of the vehicle 1. With a preceding vehicle traveling ahead of the vehicle 1, ACC performs tracking control to regulate the speed of the vehicle 1 in accordance with the distance from the preceding vehicle.

During the operation of ACC, the automatic driving controller 5 decelerates the vehicle 1 in response to the driver's braking (e.g., brake pedal operation). During the operation of ACC, the automatic driving controller 5 may accelerate the vehicle in response to the driver's acceleration (e.g., accelerator pedal operation) up to a predetermined maximum permissible speed (e.g., the legally defined maximum speed on the road being traveled). Automatic speed regulation is not limited to ACC, but may include cruise control (CC, which performs constant speed control).

The automatic driving control system according to one or more embodiments includes a mode switch control system 100. The mode switch control system 100 controls mode switching, or controls switching of the drive mode of a vehicle. The mode switch control system 100 includes a mode switch controller 6, which is a computer for controlling mode switching. Switching from the automatic drive mode to the manual drive mode will be described below.

The mode switch control system 100 includes an in-vehicle radar device 8, a front monitoring camera 11, a display 9, and a speaker 10. The in-vehicle radar device 8, which is an example of a sensor for monitoring the surroundings of the vehicle 1, radiates electric waves (radar waves) with frequencies in a gigahertz band toward, for example, the area ahead of the vehicle 1 and receives echoes of the waves. The distance to an object within the detection area of the radar is measured based on the time length taken from transmission of the radar waves to reception of the echoes. The wavelengths of the echoes may also be measured to determine the relative speed between the vehicle 1 and the object. The in-vehicle radar device 8 performs such basic signal processing to generate radar data, which is an example of the sensing data. The radar data including the distance to the object, the relative speed, and the reflection strength of the electric waves is provided to the mode switch controller 6.

The front monitoring camera 11, which is an example of the sensor for monitoring the surroundings of the vehicle 1, is mounted at, for example, the deepest position in the windshield with the field of view of the camera 11 directed in the traveling direction of the vehicle 1. The front monitoring camera 11 captures images of, for example, areas ahead of the vehicle 1 up to several hundred meters, and processes the images to generate video data. The video data, which is an example of the sensing data about the object, is provided to the mode switch controller 6.

The display 9, which is an example of a display, is a human-machine interface between an occupant of a vehicle including a driver and the mode switch controller 6. The display 9 displays a map around the vehicle and various items of information and messages. The speaker 10 also serves as a human-machine interface, and outputs voice messages.

The mode switch control system 100 may be connected to a driver camera 7. The driver camera 7 is installed at a position to capture images of the driver, such as on the dashboard, and captures images of the vehicle interior including the driver. The generated video signal is output to the mode switch controller 6.

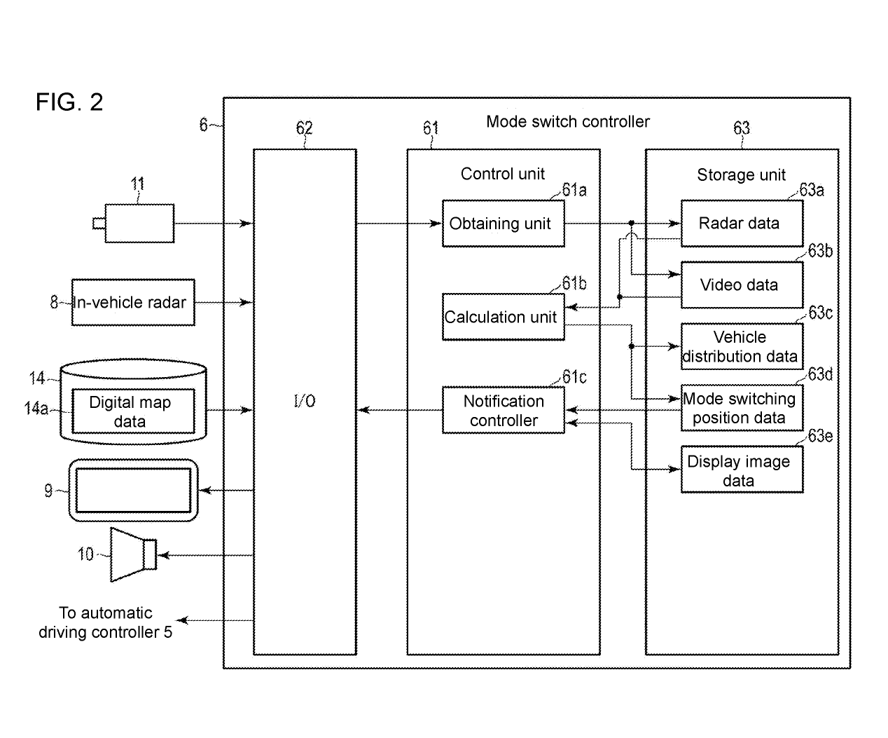

FIG. 2 is a functional block diagram of the mode switch controller 6. The mode switch controller 6 includes a control unit 61, an input-output interface (I/O) 62, and a storage 63.

The I/O 62 obtains radar data from the in-vehicle radar device 8 and video data from the front monitoring camera 11. These sets of data are stored into the storage 63 (as radar data 63a and video data 63b). The I/O 62 also obtains digital map data 14a at an address designated by the control unit 61 from the storage 14, and stores the data into the storage 63. The I/O 62 also provides display image data to the display 9 to display an intended image, and transfers sound signal data to the speaker 10 and outputs the sound signal data audibly.

The control unit 61 includes a central processing unit (CPU) included in a computer, and a memory. The control unit 61 includes, as its control functions for implementing one or more embodiments, an obtaining unit 61a, a calculation unit 61b, and a notification controller 61c. These control functions are implemented by the CPU executing programs stored in the memory.

More specifically, the obtaining unit 61a is implemented by the computer executing an instruction for obtaining, from a sensor for monitoring the surroundings of the vehicle 1, the sensing data representing the surrounding situations in the switching section defined for mode switching. The calculation unit 61b is implemented by the computer executing an instruction for calculating, based on the sensing data, a recommended mode switching position, at which mode switching is recommended in the switching section. The notification controller 61c is implemented by the computer executing an instruction for notifying the recommended mode switching position to the driver of the vehicle 1.

The obtaining unit 61a obtains the sensing data representing the surrounding situations of the vehicle 1 from a sensor for monitoring the surroundings of the vehicle 1. More specifically, the obtaining unit 61a obtains the radar data 63a from the in-vehicle radar device 8 and stores the data into the storage 63. In particular, the obtaining unit 61a obtains the radar data 63a in the switching section from the in-vehicle radar device 8 when the drive mode of the vehicle 1 is switched from the automatic drive mode to the manual drive mode.

In one or more embodiments, the switching section may refer to a section predefined for mode switching on an expressway before the exit of the interchange nearest a destination.

The calculation unit 61b calculates the recommended mode switching position at which mode switching is recommended in the switching section based on the obtained radar data 63a. More specifically, the calculation unit 61b processes the radar data 63a and calculates the distribution details of objects around the vehicle 1. Vehicle distribution data 63c generated through the processing is then stored into the storage 63. The calculation unit 61b uses the distribution details of the objects represented by the vehicle distribution data 63c as a criterion in calculating the recommended mode switching position. For example, the recommended mode switching position may be a position at which the distribution density of objects is lowest in the switching section. In other words, the position with the lowest distribution density of objects can be farthest from the obstacles.

The recommended mode switching position in one or more embodiments is a position at which the mode can be switched in the safest manner. For example, the mode switching is safest at a position farthest from obstacles. Although the mode can be switched at any position in the switching section, the structure according to one or more embodiments searches for a safer position in the switching section.

The recommended mode switching position may be expressed with numerical values, such as a latitude and a longitude or coordinates in the XY-coordinate system. The recommended mode switching position expressed with numerical values is stored into the storage 63 as recommended mode switching position data 63d.

A safe position is not limited to the recommended mode switching position, and may range across areas within the switching section. The calculation unit 61b thus calculates the distribution of numerical indexes each indicating the degree of recommendation about the mode switching in the switching section (hereafter, recommendation degree) as, for example, the inverse of the vehicle distribution data 63c.

The notification controller 61c performs control for notifying the calculated recommended mode switching position to the driver of the vehicle 1. For example, the notification controller 61c visually notifies the recommended mode switching position to the driver by generating image data including the recommended mode switching position superimposed on the map image around the vehicle 1 and displaying the data on the display 9. The map image around the vehicle 1 may be obtained by reading, from the digital map data 14a, map data corresponding to the positional information for the vehicle 1 output from the GPS receiver 15. The notification controller 61c generates display image data 63e by superimposing an icon indicating the recommended mode switching position on the map data at the coordinates corresponding to the recommended mode switching position. The display image data 63e is stored into the storage 63.

The distribution of recommendation degrees calculated by the calculation unit 61b may also be displayed visually. More specifically, the notification controller 61c generates a color map (heat map) image, which includes the recommendation degrees mapped with display colors, and stores the display image data 63e into the storage 63. The notification controller 61c reads the display image data 63e from the storage 63 and displays the data on the display 9.

The storage 63 stores the radar data 63a, the video data 63b, the vehicle distribution data 63c, the recommended mode switching position data 63d, and the display image data 63e.

The storage 63 is, for example, a semiconductor memory, such as a random access memory (RAM), a read only memory (ROM), a flash memory, and a synchronous dynamic RAM (SDRAM), or a non-volatile memory, such as an erasable programmable ROM (EPROM) and an electrically erasable programmable ROM (EEPROM). The storage 63 may also be a storage medium, such as a solid state drive (SSD) and a hard disk drive (HDD). In one or more embodiments, the storage 63 may be a storage area included in a one-chip microcomputer, such as a field programmable gate array (FPGA) or a peripheral interface controller (PIC). The advantageous effects of one or more embodiments will now be described based on the above structure.

### First Embodiment

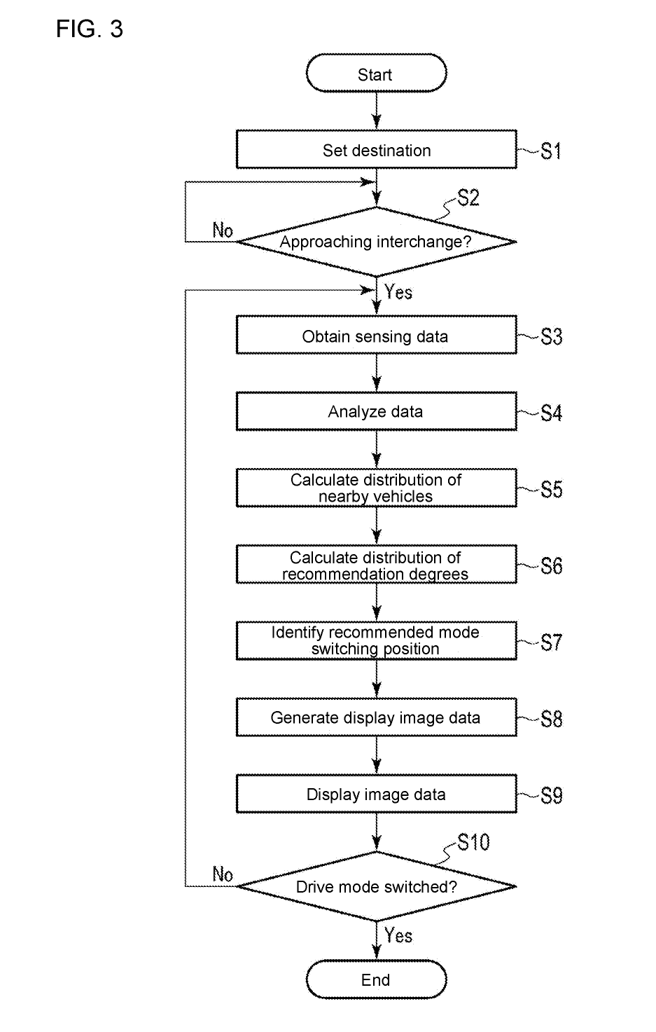

FIG. 3 is a flowchart showing an example procedure performed by the mode switch controller 6 shown in FIG. 2. In one or more embodiments, the drive mode is switched in the switching section predefined on an expressway before an interchange when a vehicle is exiting the expressway to enter an ordinary road.

In FIG. 3, in response to a destination being set in the navigation system (not shown) (step S1), for example, the mode switch controller 6 waits until approaching an interchange on the route (step S2). When recognizing that the vehicle is approaching the interchange (Yes in step S2), the mode switch controller 6 obtains radar data generated by the in-vehicle radar device 8 (step S3), and analyzes the data (step S4).

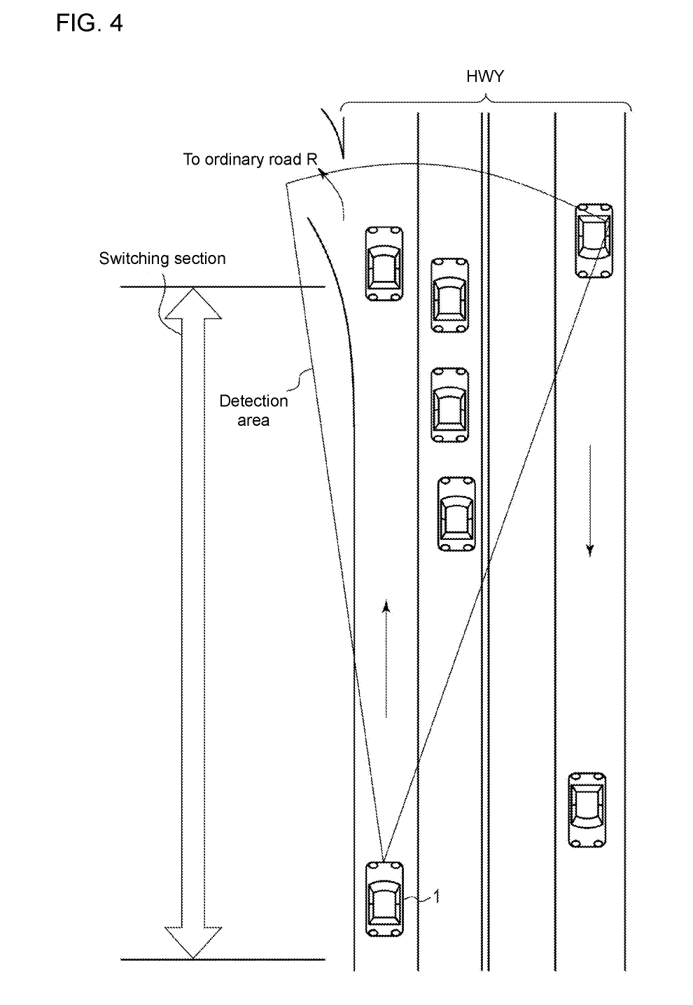

FIG. 4 is a diagram describing an example distribution of vehicles within and around the switching section. The detection area of the in-vehicle radar device 8 in the vehicle 1 is large enough to cover the switching section defined before the exit of an expressway HWY to an ordinary road R. Before entering the switching section and also within the switching section, the mode switch controller 6 analyzes the radar data from the in-vehicle radar device 8, and calculates the distribution of the nearby vehicles (step S5 in FIG. 3). The analysis result is then stored as the vehicle distribution data 63c. In the situation shown in FIG. 4, the distribution density of the nearby vehicles represented by the vehicle distribution data 63c is high at the end of the switching section and is low at the start of the switching section.

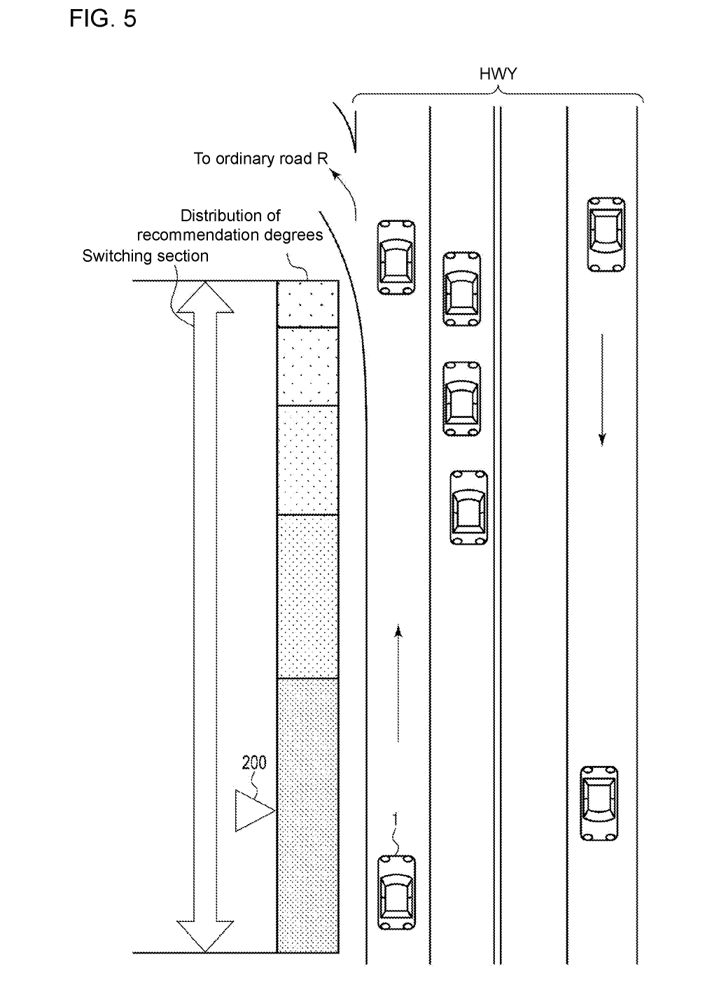

FIG. 5 is a diagram describing an example distribution of recommendation degrees in the situation shown in FIG. 4. As described above, the recommendation degree is a numerical index indicating a recommendation degree for mode switching in the switching section. The distribution of recommendation degrees is calculated to be, for example, the inverse of the vehicle distribution data 63c. In the distribution shown in FIG. 4, the recommendation degrees are high at the start of the switching section and lower toward the end. The different recommendation degrees may be hatched differently as shown in the distribution in FIG. 5.

Referring back to FIG. 3, the subsequent operation will be described. After calculating the distribution of recommendation degrees, the mode switch controller 6 identifies the position with the highest recommendation degree as the recommended mode switching position (step S7). The recommended mode switching position is indicated using, for example, a symbol icon 200 (FIG. 5).

The mode switch controller 6 then generates display image data 63e by combining, for example, a strip of color map including the recommendation degrees mapped with display colors with the latest digital map data 14a read from the storage 14 (step S8). The generated display image data 63e then promptly appears on the display 9 (step S9).

The procedure from step S3 to step S9 is repeated in cycles corresponding to, for example, the updating cycles of data appearing on the display 9 until the drive mode is switched from the automatic drive mode to the manual drive mode (step S10). Obtaining the sensing data in step S3 may be in parallel with the processing in another step. The processing in each step may be performed in orders other than the order shown in FIG. 3.

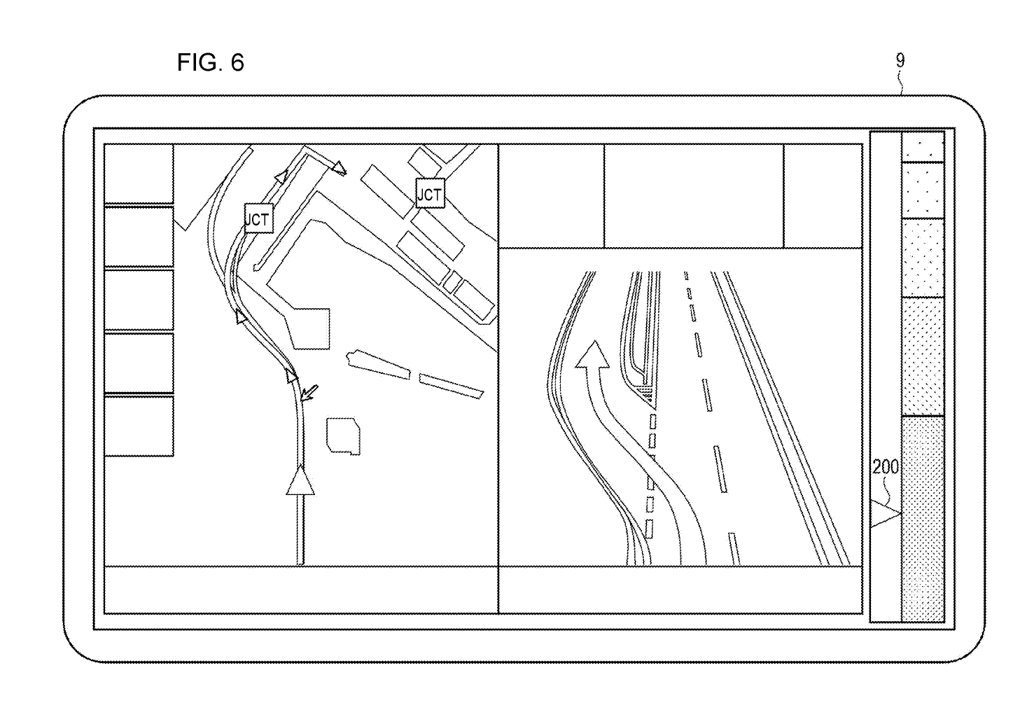

FIG. 6 is a diagram describing an example navigation screen appearing on the display 9. When the vehicle approaches the interchange on the route to the destination, the navigation screen shows, in a right side for example, a bar graph (corresponding to the strip area shown in FIG. 5) representing the switching section, together with the symbol icon 200 indicating the recommended mode switching position. The driver sees this on the display screen and can determine an appropriate position for mode switching in the switching section. Once within the switching section, the mode switching is to be completed earlier for safety as shown in FIG. 6.

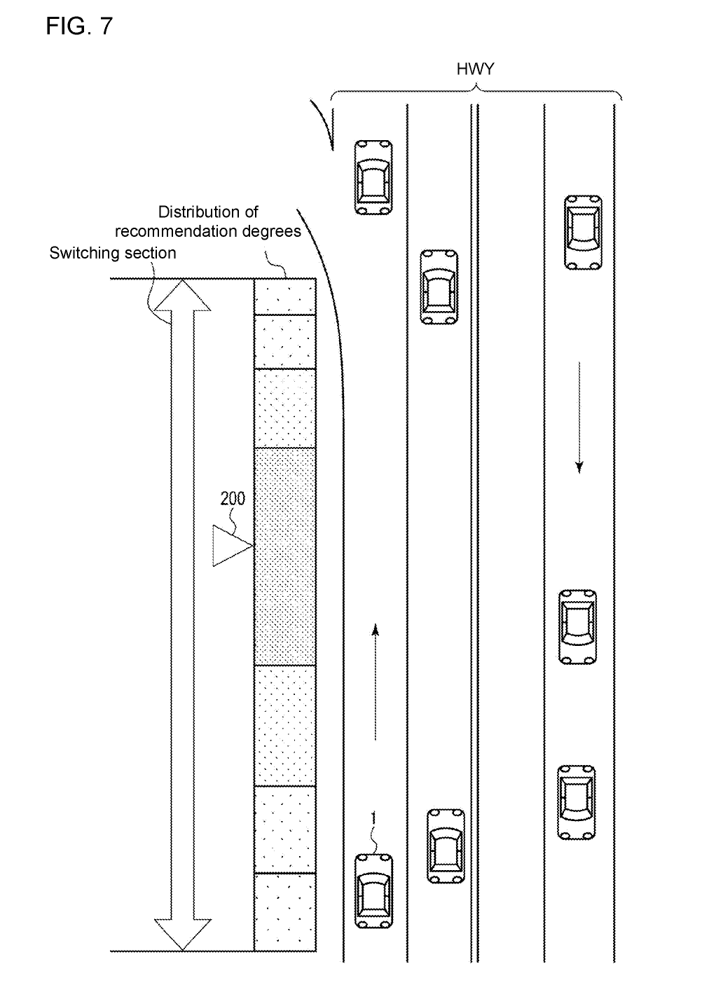

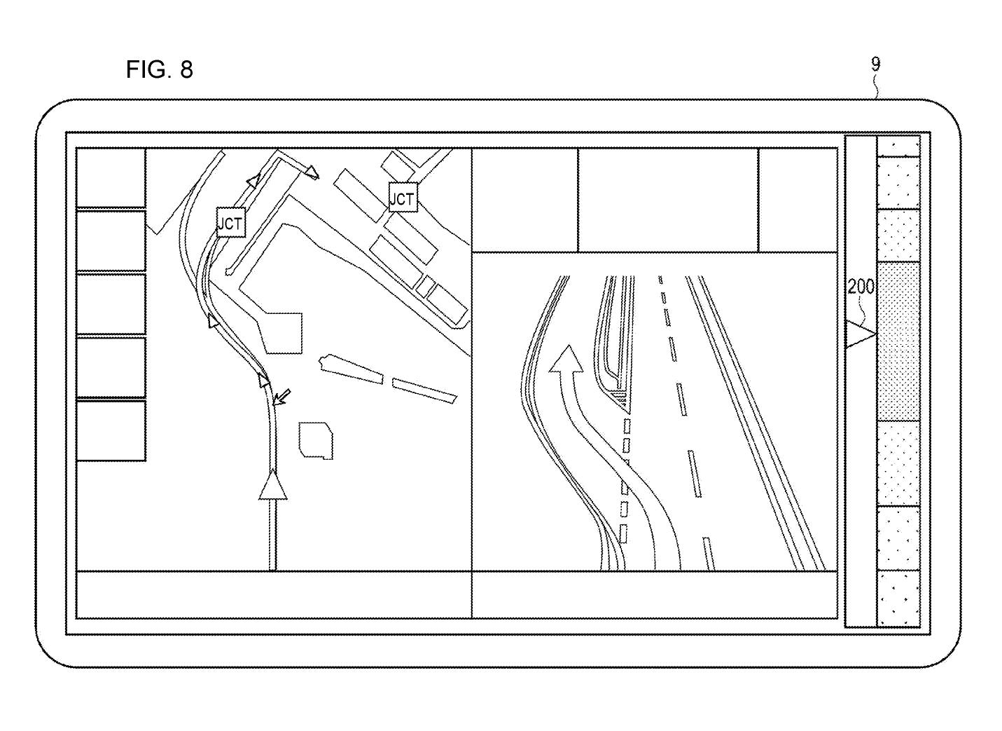

FIG. 7 is a diagram describing another example distribution of vehicles within and around the switching section. As compared with FIGS. 4 and 5, fewer vehicles are in the middle of the switching section, although some vehicles are on the right side of the vehicle 1 and at the end of the switching section. In this case, the recommendation degree is higher in the middle of the switching section, and the calculated recommended mode switching position is around the middle of the switching section. The resultant navigation screen displays, for example, the images shown in FIG. 8. The driver can then recognize that mode switching is to be safer around the middle of the switching section.

In one or more embodiments described above, the obtaining unit 61a obtains radar data from the in-vehicle radar device 8 when the vehicle approaches the switching section during driving control in the automatic drive mode. The obtaining unit 61a then provides the data to the calculation unit 61b. The calculation unit 61b analyzes the radar data, determines the distribution of vehicles around the vehicle 1, and calculates the distribution of recommendation degrees for mode switching and the recommended mode switching position based on the analysis result. The notification controller 61c generates a color map image including the distribution of recommendation degrees associated with display colors, and displays the image on the display 9.

The above structure effectively notifies a safer and more appropriate switch point in the switching section to the driver. The driver can thus switch the drive mode at a position with fewer obstacles, such as other vehicles. The structure according to one or embodiments enables switching of the drive mode at an appropriate position. The mode switch controller, the mode switch control system, the mode switch control method, and the program according to one or more embodiments can improve safety.

### Second Embodiment

In one or more embodiments, the recommended mode switching position is calculated based on the radar data obtained from the in-vehicle radar device 8. In one or more embodiments, the recommended mode switching position is calculated based on video data captured by the front monitoring camera 11.

In one or more embodiments, mode switching is performed within the switching section defined near an interchange of an expressway. In one or more embodiments, mode switching is performed within a switching section defined in response to a driver's intention.

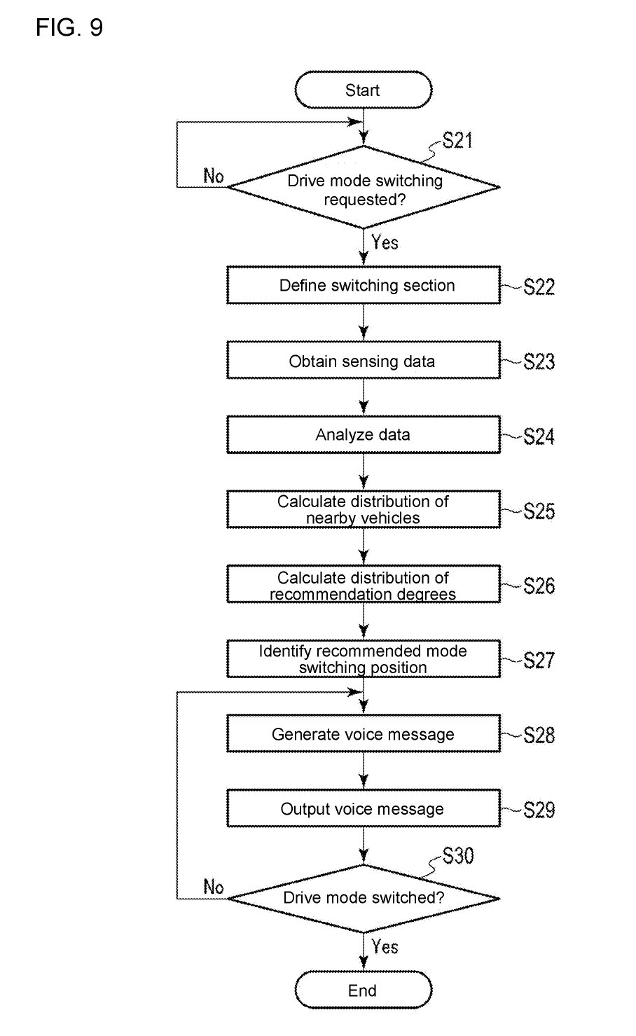

FIG. 9 is a flowchart showing an example procedure according to one or more embodiments performed by the mode switch controller 6. In FIG. 9, the mode switch controller 6 waits until receiving a drive mode switch request (an intention) from the driver. For example, in response to a switch request to the manual drive mode from the automatic drive mode (Yes in step S21), the mode switch controller 6 defines, for example, a section covering several hundred meters ahead of the vehicle as a switching section for mode switching (step S22).

The mode switch controller 6 then obtains video data generated by the front monitoring camera 11 (step S23), and analyzes the data (step S24).

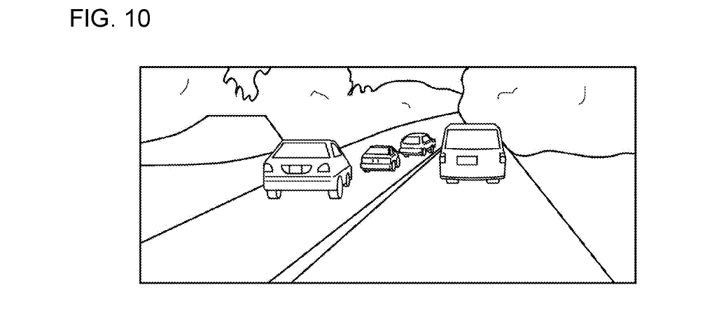

FIG. 10 is a diagram describing an example video image captured in the field of view of the front monitoring camera 11. Such video data may be analyzed with a known image processing technique, which individually identifies objects within the field of view and obtains the distribution details of such objects. For example, the vehicle distribution, as well as the road geometries and the road surface conditions, may be calculated based on the video data using an open source computer vision library (Open CV) framework. Another library dedicated to image analysis for vehicles may also be developed to generate data with higher accuracy.

The distribution of the nearby vehicles is calculated (step S25), and is stored as the vehicle distribution data 63c. The mode switch controller 6 then calculates, as in one or more embodiments, the distribution of recommendation degrees for mode switching based on the vehicle distribution data 63c (step S26), and identifies the position with the highest recommendation degree as the recommended mode switching position (step S27).

The mode switch controller 6 then generates a voice message notifying the recommended mode switching position to the driver (step S28), and outputs the message through the speaker 10 audibly (step S29).

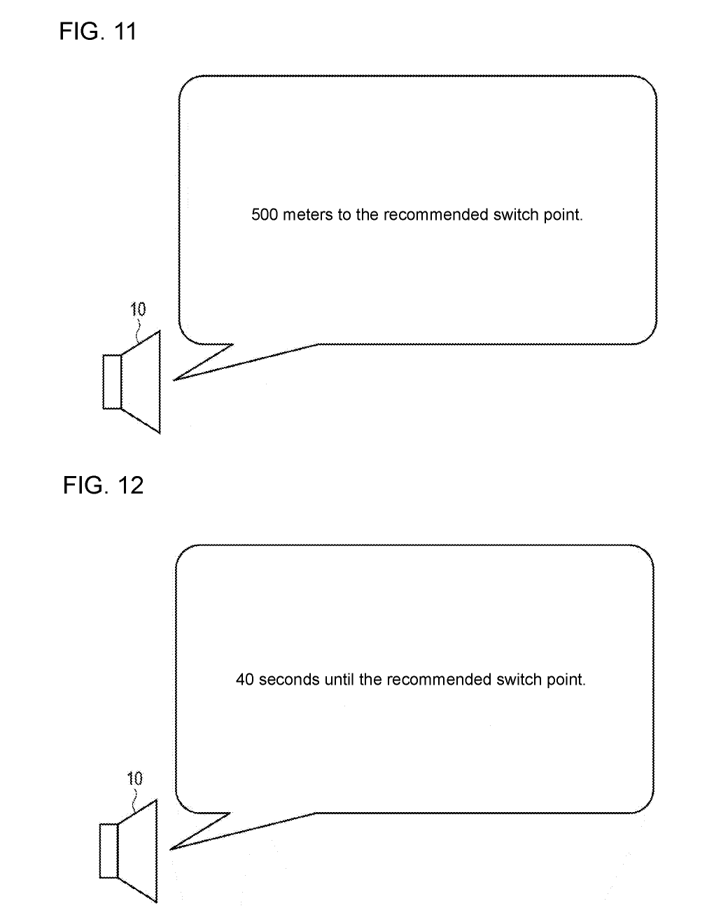

As shown in FIG. 11, the distance from the current position of the vehicle 1 to the recommended mode switching position may be calculated to output a voice message reading “500 meters to the recommended switch point.” As shown in FIG. 12, the distance from the current position of the vehicle 1 to the recommended mode switching position may be divided by the current speed to calculate the time length to reach the recommended mode switching position, and a voice message stating “40 seconds until the recommended switch point.” may be output.

In one or more embodiments, the processing in steps S28 and S29 may be repeated at relatively long intervals, such as 10 seconds, until the drive mode is switched from the automatic drive mode to the manual drive mode (Yes in step S30). Voice messages output at excessively short intervals can place psychological pressure on the driver. In the procedure shown in FIG. 9, obtaining and analyzing the video data may also be in parallel with the processing in another step.

In one or more embodiments described above, after the driver indicates his or her intention to switch from the automatic drive mode to the manual drive mode, the calculation unit 61b defines an area ahead of the vehicle as the switching section, and analyzes video data from the front monitoring camera 11 and determines the distribution of vehicles around the vehicle 1. After determining the distribution of the nearby vehicles, the calculation unit 61b calculates the distribution of recommendation degrees for mode switching and the recommended mode switching position. The notification controller 61c then, with a voice, notifies the recommended mode switching position to the driver.

The above structure effectively notifies a safer and more appropriate switch point in the switching section to the driver. The driver can thus switch the drive mode at a position with fewer obstacles, such as other vehicles.

In one or more embodiments, the driver is notified of the recommended mode switching position with a voice. A higher volume of such voice notification may awaken the driver, which can be an advantageous effect unachievable by visual notification.

In one or more embodiments, the recommended mode switching position is calculated based on video data captured by the front monitoring camera 11. The video data can provide a resolution unachievable by an electric wave-based radar device to allow more accurate position calculation. Thus, the structure according to one or more embodiments also enables drive mode switching at an appropriate position. The mode switch controller, the mode switch control system, the mode switch control method, and the program according to one or more embodiments also improve safety.

One or more embodiments are not limited to the examples described above. For example, the distribution of recommendation degrees for mode switching and the recommended mode switching position may be calculated using both the distribution of objects based on radar data obtained from the in-vehicle radar device 8 and the distribution of objects based on video data obtained from the front monitoring camera 11. Such combined use of data sets from different sensors (sensor fusion) produces advantageous effects such as improved accuracy and complementation between different data sets.

For example, a large vehicle (e.g., a truck) traveling immediately ahead in the traveling direction may obstruct the field of view of the front monitoring camera 11 used alone. The in-vehicle radar device 8 used in combination may provide data for interpolating the video data through sensing operations using the properties of electric waves such as diffraction and reflection. For example, radar data may be used mainly during night traveling, and video data may be used mainly in stormy weather, enabling more accurate calculation of the distribution of the surrounding objects reflecting the propagation properties of light and electric waves. An ultrasonic radar or other sensors may also be used.

The front monitoring camera 11 may be installed at each of multiple positions. For example, the front monitoring camera 11 may be installed on each of the right and left of the vehicle 1. In this case, the two cameras together capture a wider field of view and prevent the field of view from being obstructed by another vehicle suddenly cutting into the lane. The cameras used in combination may also provide depth information on the stereo camera principle, allowing accurate measurement of the distance to the object within the field of view. Any number of cameras (image sensors) other than two cameras may be used.

The mode switch controller 6 may be a built-in hardware device, or may be implemented as one function of an existing in-vehicle device (e.g., a car navigation system).

The mode switch controller 6 may be combined with a technique for numerically evaluating the state of the driver from video data for the driver captured by the driver camera 7. Such combination can provide a safer system, which may also determine whether a voice announcement is to be output.

The controller according to one or more embodiments may also be implemented by a computer and a program, which may be stored in a recording medium, or provided through a network. The controller according to one or more embodiments and its device components may be implemented by hardware or a combination of hardware resources and software. The software to be combined is a program preliminarily installed in a computer through a network or from a computer readable recording medium, and executed by a processor included in the computer to perform the function of each unit.

A processor used in association with a computer or the term hardware processor herein includes a circuit such as a CPU, a graphics processing unit (GPU), an application specific integrated circuit (ASIC), a simple programmable logic device (SPLD), a complex programmable logic device (CPLD), and an FPGA.

The processor reads a program stored in the memory and executes the program to implement the specific functions based on the program. The program may not be stored in the memory but may be directly incorporated in the circuit of the processor. In that case, the processor reads the program incorporated in the circuit to perform the functions.

Other details including the type of vehicle, the functions of the automatic driving controller, and the functions, procedure, and control of the mode switch controller may be modified variously without departing from the spirit and scope of the present invention.

The present invention is not limited to one or more embodiments, but the components may be modified without departing from the spirit and scope of the invention. The components described in one or more embodiments may be combined as appropriate to provide various aspects. For example, some of the components described in one or more embodiments may be eliminated. Further, components in different embodiments may be combined as appropriate.

One or more embodiments may be partially or entirely expressed in, but not limited to, the following forms shown in the appendixes below.

### APPENDIX 1

A mode switch controller for controlling mode switching to switch a drive mode of a vehicle between a manual drive mode and an automatic drive mode, the controller comprising a hardware processor and a memory, the hardware processor being configured to

obtain, from a sensor for monitoring surroundings of the vehicle, sensing data representing a surrounding situation in a switching section defined for the mode switching,

calculate a recommended mode switching position at which mode switching is recommended in the switching section based on the sensing data, and

store positional information indicating the calculated recommended mode switching position into the memory.

### APPENDIX 2

A mode switch control system for controlling mode switching to switch a drive mode of a vehicle between a manual drive mode and an automatic drive mode, the system comprising a sensor configured to monitor surroundings of the vehicle and output sensing data representing a surrounding situation of the vehicle, a hardware processor, and a memory, the hardware processor being configured to

obtain the sensing data representing the surrounding situation in a switching section defined for the mode switching from the sensor,

calculate a recommended mode switching position at which mode switching is recommended in the switching section based on the sensing data, and

store positional information indicating the calculated recommended mode switching position into the memory.

### APPENDIX 3

A mode switch control method for controlling, with a computer, mode switching to switch a drive mode of a vehicle between a manual drive mode and an automatic drive mode, the method comprising:

obtaining, with at least one hardware processor, sensing data representing a surrounding situation in a switching section defined for the mode switching from a sensor for monitoring surroundings of the vehicle; and

calculating, with the at least one hardware processor, a recommended mode switching position at which mode switching is recommended in the switching section based on the sensing data.

1. A mode switch controller for controlling mode switching to switch a drive mode of a vehicle between a manual drive mode and an automatic drive mode, the controller comprising a processor configured with a program to perform operations comprising:
operation as an obtaining unit configured to obtain, from an in-vehicle sensor for monitoring surroundings of the vehicle, sensing data representing a surrounding situation in a switching section defined for the mode switching; and
operation as a calculation unit configured to calculate a recommended mode switching position at which mode switching is recommended in the switching section based on the sensing data.

2. The mode switch controller according to claim 1, wherein
the processor is configured with the program to perform operations such that operation as the calculation unit is further configured to calculate the recommended mode switching position using a distribution of objects around the vehicle as a determination criterion.

3. The mode switch controller according to claim 2, wherein
the processor is configured with the program to perform operations such that operation as the calculation unit is further configured to determine a position with a lowest distribution density of the objects in the switching section as the recommended mode switching position.

4. The mode switch controller according to claim 1, wherein the processor is configured with the program to perform operations further comprising:
operation as a notification control unit configured to notify the recommended mode switching position to a driver of the vehicle.

5. The mode switch controller according to claim 4, wherein
the processor is configured with the program to perform operations such that operation as the notification control unit is further configured to display the recommended mode switching position superimposed on a map image of the surroundings of the vehicle on a display.

6. The mode switch controller according to claim 5, wherein the processor is configured with the program to perform operations such that:
operation as the calculation unit is further configured to calculate a distribution of numerical indexes each indicating a degree of recommendation about the mode switching in the switching section, and
operation as the notification control unit is further configured to associate the indexes with display colors on the map image to display the indexes in a color map.

7. The mode switch controller according to claim 4, wherein
the processor is configured with the program to perform operations such that operation as the notification control unit is further configured to notify, with a voice, a time length to reach the recommended mode switching position to the driver of the vehicle.

8. The mode switch controller according to claim 1, wherein
the in-vehicle sensor comprises a radar device that radiates electric waves toward a detection area including an area in a traveling direction of the vehicle and obtains radar data within the detection area based on echoes of the waves.

9. The mode switch controller according to claim 1, wherein
the in-vehicle sensor comprises an image sensor that captures images in a field of view including an area in a traveling direction of the vehicle and obtains video data within the field of view.

10. The mode switch controller according to claim 2, wherein the processor is configured with the program to perform operations further comprising:
operation as a notification control unit configured to notify the recommended mode switching position to a driver of the vehicle.

11. The mode switch controller according to claim 10, wherein
the processor is configured with the program to perform operations such that operation as the notification control unit is further configured to display the recommended mode switching position superimposed on a map image of the surroundings of the vehicle on a display.

12. The mode switch controller according to claim 11, wherein the processor is configured with the program to perform operations such that:
operation as the calculation unit is further configured to calculate a distribution of numerical indexes each indicating a degree of recommendation about the mode switching in the switching section, and
operation as the notification control unit is further configured to associate the indexes with display colors on the map image to display the indexes in a color map.

13. The mode switch controller according to claim 10, wherein
the processor is configured with the program to perform operations such that operation as the notification control unit is further configured to notify, with a voice, a time length to reach the recommended mode switching position to the driver of the vehicle.

14. The mode switch controller according to claim 3, wherein the processor is configured with the program to perform operations further comprising:
operation as a notification control unit configured to notify the recommended mode switching position to a driver of the vehicle.

15. The mode switch controller according to claim 14, wherein
the processor is configured with the program to perform operations such that operation as the notification control unit is further configured to display the recommended mode switching position superimposed on a map image of the surroundings of the vehicle on a display.

16. The mode switch controller according to claim 15, wherein the processor is configured with the program to perform operations such that:
operation as the calculation unit is further configured to calculate a distribution of numerical indexes each indicating a degree of recommendation about the mode switching in the switching section, and
operation as the notification control unit is further configured to associate the indexes with display colors on the map image to display the indexes in a color map.

17. The mode switch controller according to claim 14, wherein
the processor is configured with the program to perform operations such that operation as the notification control unit is further configured to notify, with a voice, a time length to reach the recommended mode switching position to the driver of the vehicle.

18. A mode switch control system for controlling mode switching to switch a drive mode of a vehicle between a manual drive mode and an automatic drive mode, the system comprising:
an in-vehicle sensor configured to monitor surroundings of the vehicle and output sensing data representing a surrounding situation of the vehicle; and
a processor configured with a program to perform operations comprising:
operation as an obtaining unit configured to obtain the sensing data representing the surrounding situation in a switching section defined for the mode switching from the in-vehicle sensor; and
operation as a calculation unit configured to calculate a recommended mode switching position at which mode switching is recommended in the switching section based on the sensing data.

19. A mode switch control method for controlling, with a computer, mode switching to switch a drive mode of a vehicle between a manual drive mode and an automatic drive mode, the method comprising:
obtaining, with the computer, sensing data representing a surrounding situation in a switching section defined for the mode switching from an in-vehicle sensor for monitoring surroundings of the vehicle; and
calculating, with the computer, a recommended mode switching position at which mode switching is recommended in the switching section based on the sensing data.

20. A non-transitory computer-readable storage medium storing a program, which when read and executed, causes a computer to function as the mode switch controller according to claim 1.
